(19) United States
(12) Patent Application Publication
(10) Pub. No.: US 2016/0252151 A1
(43) Pub. Date: Sep. 1, 2016

(54) Brake for rockfall protecting net

(71) Applicant: Asia Professional Limited, HONG KONG (CN)

(72) Inventor: Yuen Kwan Chan, HONG KONG (CN)

(73) Assignee: Asia Professional Limited

(21) Appl. No.: 15/055,530

(22) Filed: Mar. 29, 2016

(30) Foreign Application Priority Data
Feb. 27, 2015 (HK) 15102017.8

(51) Int. Cl. F16F 7/12; E01F 7/04

(52) U.S. Cl. CPC F16F 7/126; E01F 7/045

(57) ABSTRACT

A brake for a rockfall protection net includes a housing, at least three rolling shafts, and a metallic deformed plate. Force exerting sections of the rolling shafts are movably arranged in the housing and parallel with each other. At least one rolling shaft is not located on a same plane where the other rolling shafts are located. A first end of the metallic deformed plate penetrates into the housing from a back end of the housing and stretches out from a front end of the housing. A deformed section of the metallic deformed plate is located in the housing. The force exerting sections of al least two rolling shafts contact a first surface A of the metallic deformed plate, and the force exerting section of at least one rolling shaft contacts a second surface B of the metallic deformed plate.

### CROSS REFERENCE OF RELATED APPLICATION

The present application claims priority under 35 U.S.C. 119(a-d) to HK 15102017.8, filed Feb. 27, 2015.

### BACKGROUND OF THE PRESENT INVENTION

1. Field of Invention

The present invention relates to a protection net arranged on a mountain slope for preventing rocks and earth from falling down to a road to damage pedestrians and vehicles, and more particularly to a brake for a rope of the protection net.

2. Description of Related Arts

Conventionally, a protection device is arranged outside the mountain slope, for preventing the rocks and the earth on the slope from falling down to the road below the slope to damage the pedestrians and the vehicles. The protection device conventionally comprises: a standing column, which is connected with a first edge of a protection net; the protection net with a second edge corresponding to the first edge and fixedly arranged at a bottom of the slope; and a plurality of steel wire ropes with first ends fixedly connected with the mountain slope and second ends connected with the standing column. When the rocks or the earth falls down, the protection net receives the instantaneous impact force, and then transmits the impact force to the standing column and further to the steel wire ropes, causing the steel wire ropes to be stretched. In order to prevent the steel wire ropes from being broken by the instantaneous impact force, it is necessary to arrange buffering and braking mechanisms. Conventionally, each steel wire rope is knotted at the middle of the steel wire rope, and a braking ring is arranged at a position where two steel wire ropes are connected with each other, so as to achieve the buffering and braking effects. However, the ring at the position where the two steel wire ropes are connected with each other has a too small size, and the friction between the metals is too high, which causes the steel wire ropes to be broken, so that the protection net falls down, thereby leaving a great potential safety risk.

### SUMMARY OF THE PRESENT INVENTION

An object of the present invention is to provide a brake for a rockfall protection net, which has good buffering and braking effects, and to solve problems in prior arts.

In order to accomplish the above object, following technical solutions are adopted.

A brake for a rockfall protection net comprises: a housing, at least three rolling shafts, and a metallic deformed plate; wherein: force exerting sections of the rolling shafts are movably arranged in the housing and parallel with each other; at least one rolling shaft is not located on a same plane where the other rolling shafts are located; a first end of the metallic deformed plate penetrates into the housing from a back end of the housing and stretches out from a front end of the housing; a deformed section of the metallic deformed plate is located in the housing; the force exerting sections of at least two rolling shafts contact a first surface A of the metallic deformed plate; and the force exerting section of at least one rolling shaft contacts a second surface B of the metallic deformed plate.

Preferably, each rolling shaft is formed through integrally molding the force exerting section and two connection ends which are respectively located at two ends of the force exerting section; the two connection ends respectively stretch out of two lateral plates of the housing; and a bolt hole is provided on each connection end.

Preferably, an amount of the rolling shafts is three; and axes of two of the rolling shafts which contact the first surface A of the metallic deformed plate are located on the same plane.

Preferably, a stopping part is arranged at a second end of the metallic deformed plate; and a hanging hole is provided on the first end of the metallic deformed plate.

Preferably, an end of a bottom plate of the housing stretches outward and forms an extending part; and a connection hole is provided on the extending part.

The present invention has following beneficial effects.

The brake comprises the housing, the metallic deformed plate, and the three rolling shafts. The hanging hole is provided on the first end of the metallic deformed plate and connected with a first steel wire rope which is tied on the standing column for supporting the rockfall protection net. The end of the bottom plate of the housing stretches outward for forming the extending part. The connection hole is provided on the extending part and connected with a second steel wire rope which is fixed on a mountain. Moreover, the metallic deformed plate penetrates through the housing and the deformed section of the metallic deformed plate is located in the housing. The two of the rolling shafts which are located on the same plane contact the first surface A of the deformed section of the metallic deformed plate, and the rest one of the rolling shafts which is not located on the same plane where the other two rolling shafts are located contacts the second surface B of the deformed section, namely a connection line of ends of the axes of the three rolling shafts is in a triangular shape or an inverted triangular shape. When passing through the three rolling shafts, a section of the metallic deformed plate, which is located in the housing, is inevitably deformed and thus named as the deformed section; and a resistance is generated during deforming. When the rockfall protection net receives an instantaneous impact force of rockfall and earth, the rockfall protection net transmits the impact force to the standing column for supporting; the first steel wire rope which is located in front of the brake and connected with the standing column pulls the metallic deformed plate, in such a manner that the deformed section of the metallic deformed plate moves among the three rolling shafts and is squeezed and deformed, for generating the resistance and a braking effect. The stopping part is arranged at the second end of the metallic deformed plate. When the metallic deformed plate is pulled forward by the impact force, the stopping part is able to resist against the back end of the housing, so as to prevent the metallic deformed plate from separating from the housing and thus prevent the standing column for supporting the rockfall protection net from falling down. Each rolling shaft is formed through integrally molding the force exerting section and the two connection ends which are respectively located at the two ends of the force exerting section. The two connection ends of each rolling shaft respectively stretch out of the two lateral plates of the housing. A bolt hole is provided on each connection end. Through different bolts or components, a rotation range of each rolling shaft is adjusted, so as to change a braking force of the present invention. Moreover, the two steel wire ropes have no contact, and thus no friction force is generated, which prevents the steel wire ropes from being broken and eliminates a potential safety risk.

These and other objectives, features, and advantages of the present invention will become apparent from the following detailed description, the accompanying drawings, and the appended claims.

### BRIEF DESCRIPTION OF THE DRAWINGS

FIG. 1 is a longitudinal sectional view of a brake for a rockfall protection net according to a preferred embodiment of the present invention.

FIG. 2 is a cross sectional view of the brake for the rockfall protection net according to the preferred embodiment of the present invention.

FIG. 3 is a sketch view of the brake for the rockfall protection net according to the preferred embodiment of the present invention.

### DETAILED DESCRIPTION OF THE PREFERRED EMBODIMENT

For one skilled in the art to better understand the present invention, the present invention is further illustrated in detail with the accompanying drawings and the preferred embodiment.

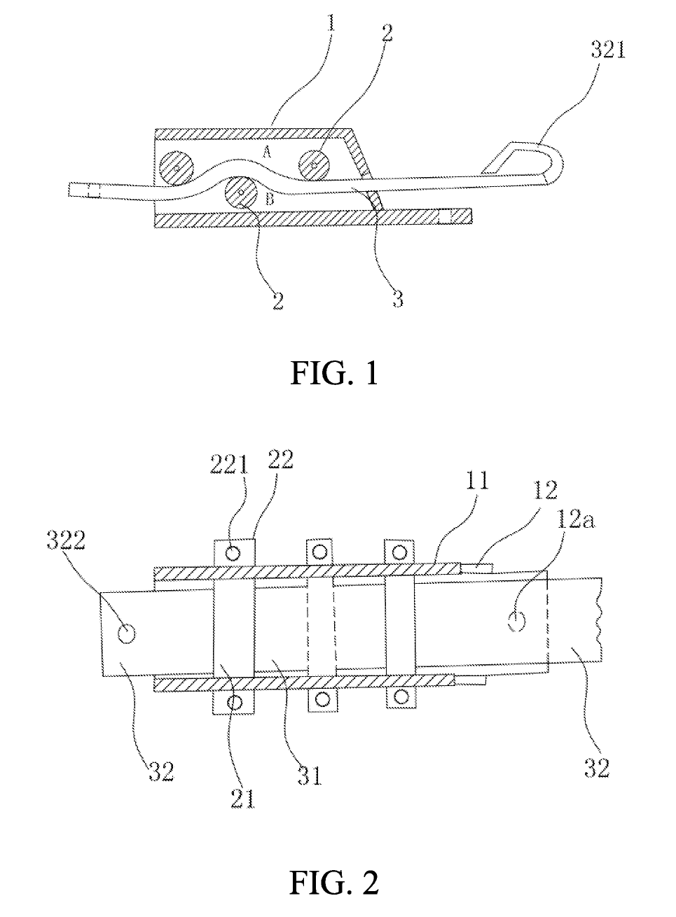

As showed in FIGS. 1-2, a brake for a rockfall protection net comprises: a housing 1, three rolling shafts 2, and a metallic deformed plate 3. According to the preferred embodiment of the present invention, an amount of the rolling shafts is three, while it is feasible to adopt more than three rolling shafts. Each rolling shaft 2 is formed through integrally molding a force exerting section 21 and two connection ends 22 which are respectively located at two ends of the force exerting section 21. The two connection ends 22 respectively stretch out of two lateral plates 11 of the housing 1. A bolt hole 221 is provided on each connection end, for inserting a bolt to prevent every rolling shaft from rolling out of the housing 1. The force exerting sections of the rolling shafts 2 are movably arranged in the housing 1 and parallel with each other. The three rolling shafts are arranged in a triangular shape or an inverted triangular shape, namely a connection line of ends of axes of the three rolling shafts 2 is in the triangular shape or the inverted triangular shape. The rolling shaft which is located above or below the other two rolling shafts is not located on a same plane where the other two rolling shafts are located.

Furthermore, it is feasible to arrange a bolt at a position of the bolt hole and arrange a nut on the bolt, so as to prevent the rolling shafts from rolling out.

Furthermore, the housing 1 is square.

Furthermore, the metallic deformed plate 3 is formed through integrally molding a deformed section 31 and two connection sections 32 which are respectively located at two ends of the deformed section. A front end of the metallic deformed plate 3 penetrates into the housing 1 from a back end of the housing and stretches out from a front end of the housing. The deformed section 31 of the metallic deformed plate is located in the housing 1. The force exerting sections of two of the three rolling shafts contact a first surface A of the deformed section 31 of the metallic deformed plate, namely contact the first surface A of the metallic deformed plate, and the force exerting section of the rest one of the three rolling shafts contacts a second surface B of the metallic deformed plate 3.

Furthermore, a stopping part 321 is located at a back end of the metallic deformed plate 3. A hanging hole 322 is provided on the front end of the metallic deformed plate.

Furthermore, through changing the amount of the rolling shafts 2, an amount of deformed points on the deformed section 31 of the metallic deformed plate 3 is changed, so as to change a resistance. Through changing a distance between two of the rolling shafts 2 which are located on the same plane, a vertical distance between the rest one of the rolling shafts and the two of the rolling shafts, and diameters of the rolling shafts, a bended and deformed length of the deformed section is changed, so as to change a deformation resistance.

Furthermore, an end of a bottom plate 12 of the housing 1 stretches outward for forming an extending part; a connection hole 12a is provided on the extending part.

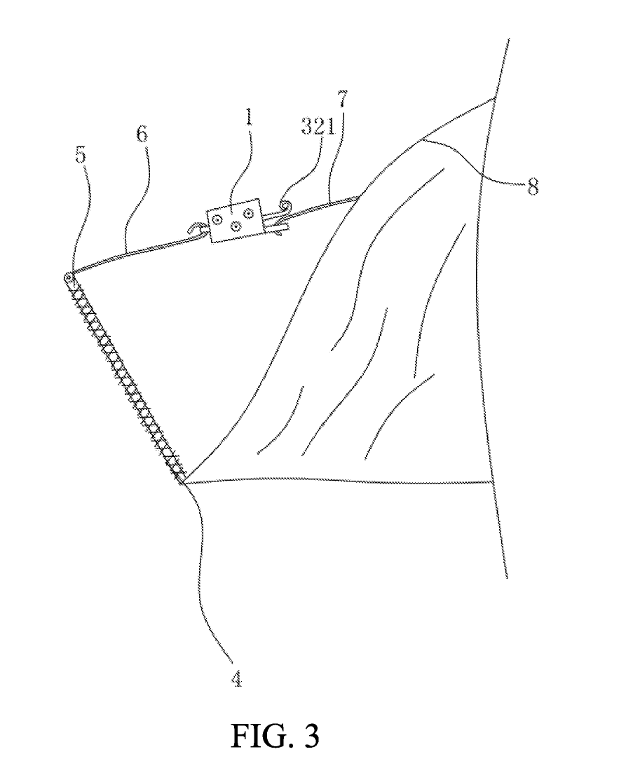

As showed in FIG. 3, in order to further illustrate the preferred embodiment of the present invention, a protection net 4, a standing column 5, a first steel wire rope 6, and a second steel wire rope 7 are introduced, wherein: a lower edge of the protection net is fixed at a lower part of a mountain slope 8 through the standing column; the first steel wire rope 6 has a front end fixedly connected with the standing column, and a back end connected with the hanging hole 322; the second steel wire rope 7 has a front end connected with the connection hole 12a and a back end fixedly connected with an upper part of the mountain slope 8.

When the protection net 4 receives an instantaneous impact force of rockfall and earth, the protection net transmits the impact force to the standing column 5 for supporting; the first steel wire rope 6, which is located in front of the brake and connected with the standing column, forward pulls the metallic deformed plate, in such a manner that the deformed section of the metallic deformed plate moves among the three rolling shafts and is squeezed and deformed, for generating a resistance and a braking effect. The stopping part 321 is arranged at the back end of the metallic deformed part. When the metallic deformed plate is pulled forward by the impact force, the stopping part is able to resist against the back end of the housing, so as to prevent the metallic deformed plate from separating from the housing and thus prevent the standing column for supporting the protection net from falling down. Each rolling shaft is formed through integrally molding the force exerting section and the two connection ends which are respectively located at the two ends of the force exerting section. The two connection ends of each rolling shaft respectively stretch out of the two lateral plates of the housing. The bolt hole 221 is provided on each connection end. Through different bolts or components, a rotation range of each rolling shaft is adjusted, so as to change a braking force of the present invention.

The brake, provided by the present invention, is applicable in not only the steel wire ropes between the mountain slope and the protection net, but also the steel wire ropes on two sides of the protection net, and has certain braking effect.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A brake for a rockfall protection net, comprising: a housing, at least three rolling shafts, and a metallic deformed plate; wherein:
force exerting sections of said rolling shafts are movably arranged in said housing and are parallel with each other, wherein at least one rolling shaft is not located on a same plane where the other rolling shafts are located;
a first end of said metallic deformed plate penetrates into said housing from a front end of said housing and stretches out from a back end of said housing, a deformed section of said metallic deformed plate is located in said housing; and
said force exerting sections of at least two rolling shafts contact a first surface (A) of said metallic deformed plate; and said force exerting section of at least one rolling shaft contacts a second surface (B) of said metallic deformed plate.

2. The brake for the rockfall protection net, as recited in claim 1, wherein: each rolling shaft is formed through integrally molding said force exerting section and two connection ends which are respectively located at two ends of said force exerting section; said two connection ends respectively stretch out of two lateral plates of said housing; and a bolt hole is provided on each connection end.

3. The brake for the rockfall protection net, as recited in claim 1, wherein: an amount of said rolling shafts is three; and axes of two of said rolling shafts which contact said first surface (A) of said metallic deformed plate are located on the same plane.

4. The brake for the rockfall protection net, as recited in claim 2, wherein: an amount of said rolling shafts is three; and axes of two of said rolling shafts which contact said first surface (A) of said metallic deformed plate are located on the same plane.

5. The brake for the rockfall protection net, as recited in claim 1, wherein: a stopping part is arranged at a second end of said metallic deformed plate; and a hanging hole is provided on said first end of said metallic deformed plate.

6. The brake for the rockfall protection net, as recited in claim 1, wherein: an end of a bottom plate of said housing stretches outward for forming an extending part; and a connection hole is provided on said extending part.

7. The brake for the rockfall protection net, as recited in claim 2, wherein: an end of a bottom plate of said housing stretches outward for forming an extending part; and a connection hole is provided on said extending part.
